(19) United States
(12) Patent Application Publication
(10) Pub. No.: US 2009/0139460 A1
(43) Pub. Date: Jun. 4, 2009

(54) Insulated wood duck house

(76) Inventor: Norbert Sonnek, Wells, MN (US)

Correspondence Address: Norbert P. Sonnek, 56721 - 190th Street, Wells, MN, 56097, US

(21) Appl. No.: 12/075,291

(22) Filed: Mar. 11, 2008

Related U.S. Application Data
(60) Provisional application No. 60/906,909, filed on Mar. 13, 2007.

(51) Int. Cl. A01K 31/14

(52) U.S. Cl. 119/435

(57) ABSTRACT

The present invention relates to the use of a chemical foaming agent as insulation for a cylindrical plastic wood duck house. A second aspect of the present invention is the inspection door that fits snugly into a depression of matching size on the side of the cylindrical wood duck house. A third aspect of the present invention relates to securing the wood duck house to a round plastic PVC pole. The neck at the base of the wood duck house rests atop and over a round plastic PVC pole of slightly smaller diameter. The security collar of the present invention snaps snuggly onto the neck of the wood duck house. The peg on the inside security collar fits into an opening on the neck of the wood duck house and then through an opening on the round plastic PVC pole. The peg on the security collar acts as a spear through the neck of the wood duck house and the pole to stabilize and secure the wood duck house to the pole. The fourth aspect of the present invention relates to a two part connecting device with one end of smaller diameter fitting under and inside the neck of the wood duck house. The other end of the connecting device of larger diameter fits over the top of a round plastic PVC pole. The top of the connecting device with the smaller diameter has a hole on the side of the same size as the peg on the security collar. The connecting device is an adapter coupler to engage the wood duck house to the round PVC pole without the need for additional tools.

REFERENCES CITED

| | | |
|---|---|---|
| 6,880,486 | April 2005 | Sonnek |
| 3,643,631 | February 1972 | Wade et al. |
| 4,889,075 | December 1989 | Byrns |
| 6,858,805 | February 2005 | Blew et al. |
| 6,729,077 | May 2004 | Nickell et al. |
| 6,959,516 | November 2005 | Williamson et al. |
| 4,928,631 | May 1990 | Smith |
| 5,765,505 | March 1997 | Yun |
| 3,792,685 | February 1974 | Weiner |
| 4,442,793 | April 1984 | Overpeck |
| 6,009,837 | January 2000 | McClasky |
| 6,578,876 | June 2003 | Guertin, Jr. |
| 7,124,453 | October 2006 | Sun |
| 5,776,117 | June 1996 | Haselhorst |
| 6,009,901 | January 1998 | Roberts |
| 5,569,222 | June 1994 | Haselhorst |
| 5,809,930 | February 1997 | Brooks |
| 5,870,968 | January 1995 | Dundorf |

### DESCRIPTION OF PRIOR ART

Some migratory fowl, such as the wood duck, fly to northern climates during very early spring when there are uncertain and changing weather conditions. The wood duck lays her eggs and sits on the eggs during a month long incubation period. For the best chance of egg survival and hatching it is imperative the eggs remain at an optimum temperature, neither too cold, nor too warm. The prior art shows several birdhouses were made with insulating factors. U.S. Pat. No. 3,643,631 by Wade shows a metal birdhouse with double wall construction. The double wall served to provide some insulation to the interior of the birdhouse. U.S. Pat. No. 4,889,075 by Byrns shows a plastic wood duck house also with a double wall construction. There are no double walls in the present invention. The present invention improves on the prior art by providing an insulated wood duck house where the insulation has become part of the plastic material of the entire wood duck house. A chemical foaming agent has been infused into the plastic material to create spatial openings within the plastic material on the inside of the wood duck house. This extra spacing acts to insulate the entire bird house from weather extremes. The insulation factor helps insure the best temperature quality control for successful egg hatching. The outside surface of the cylindrical wood duck house remains smooth and round to deter predators. The thickness of all sides of the wood duck house has been increased due to the chemical foaming agent creating the insulating spaces within the plastic material. U.S. Pat. No. 6,858,805 by Blew shows the use of a foamed plastic insulation used in electrical wiring. Both U.S. Pat. No. 6,729,077 by Nickell and U.S. Pat. No. 6,959,516 by Williamson show the use of a plastic foaming agent in plastic building materials. In both Blew and Williamson the inventors infused insecticide into the plastic building material to manufacture wall and flooring materials that would prevent insects from coming into a building.

The prior art shows several birdhouses have been designed with doors for observation or ease of cleaning nesting and hatching materials from the unit. U.S. Pat. No. 4,928,631 by Smith shows a viewing window with a hinged shutter. U.S. Pat. No. 5,765,505 by Yun provides walls that slide on grooves to be removed for easy clean up of the nesting and hatched material. U.S. Pat. No. 3,792,685 by Wiener shows removable walls for gaining access to the interior of the bird house for easy clean up. U.S. Pat. No. 4,442,793 by Overpeck shows another design in which the bottom of the birdhouse drops away for easy clean up after the birds have hatched and left the nesting compartment. U.S. Pat. No. 6,009,837 by McClasky also shows side walls that can be removed for cleaning of the birdhouse interior. The present invention improves upon the prior art by providing an easy to operate inspection door for quick direct observation of a nesting wood duck and nest without disturbing the wood duck. The inspection door of the present invention can be opened and closed with one hand. The inspection door of the present invention has a wing nut at the lower end of the door. The wing nut can easily be turned by hand to disengage the inspection door from the wood duck house. Once the wing nut is disengaged from the wood duck house the inspection door can easily slide out from under the overhanging flange for a full view of the interior. This can all be accomplished with one hand and no additional tools. After inspection of the interior of the wood duck house the inspection door can be placed back into position by sliding it under the overhanging flange. The wing nut can be turned to reengage the inspection door to the same size depression in the side of the wood duck house.

The cylindrical wood duck house is fitted on top of a long PVC pole to allow height advantage for the wood duck and prevent predators from entering the nesting chamber. It is imperative to keep the wood duck house stable. The security collar of the present invention serves that purpose without using additional tools. U.S. Pat. No. 5,809,930 by Brooks shows two U-shaped collars on a flagpole to allow a flag to rotate freely around a pole without entanglement about the pole. U.S. Pat. No. 5,870,968 by Dundorf shows another flag pole with a series of bearing collars to prevent the flag from wrapping around the pole. The security collar of the present invention does not rotate. In fact, the purpose of the security collar of the present invention is to prevent movement of the wood duck house as it sits atop the PVC pole. The security collar in the present invention fits snugly around the neck of the wood duck house and snaps in place without additional tools. The inside concave surface of the security collar includes a peg protruding from the center of the concave surface. As the security collar is snapped into place the peg on the concave surface of the security collar engages the hole on the neck of the wood duck house then protrudes into a similar size hole on the PVC pole to engage the pole. The security collar with peg secures the wood duck house to the pole and keeps them locked together to prevent movement of the wood duck house due to wind disturbance. There are bird enthusiasts who do not want the inconvenience of drilling a hole in a PVC pole to accept the peg of the security collar. The present invention provides an alternate connecting device with a hole already made to accept the peg of the security collar. U.S. Pat. No. 6,578,876 by Guertin, Jr. shows several threaded adapter couplers that connect separate pieces of hose for a fluid tight seal. U.S. Pat. No. 7,124,453 by Sun shows a tubular coupler that provides a water tight seal for a shower head connection to the pipe inside the shower wall. U.S. Pat. Nos. 5,776,117 and 5,569,222 both by Haselhorst show a series of adapters to provide for fluid inside tubes. U.S. Pat. No. 6,009,901 by Roberts shows a coupler to connect one fluid conduit to another. The adapter coupler of the present invention eliminates the need for additional tools when erecting the wood duck house atop the PVC pole. The upper section of the adapter coupler of the present invention is made with a hole on its side. The diameter of the hole matches the diameter of the peg of the security collar. The peg on the security collar fits into the hole on the upper section of the adapter coupler. The lower section of the adapter coupler has a diameter slightly larger than the diameter of the upper section. The upper section of the adapter coupler is fitted inside the lower section. The lower section of the adapter coupler has a diameter slightly larger than the diameter of the PVC pole. The lower section of the adapter coupler fits over the PVC pole. Thus, the adapter coupler joins the wood duck house above to the PVC pole below without the need for additional tools. The declining diameters of the neck of the wood duck house, the adapter coupler and the PVC pole insure that water cannot leak inside the PVC pole but simply runs down the outside of the PVC pole. The life of the PVC pole is not diminished when water cannot get inside the pole, then freeze, expand and crack the plastic material of the PVC pole.

### DRAWINGS

FIG. 1 is top down view of wood duck house showing inspection door fitting snugly under an overhead flange. The inspection door is fitted into a depression of the same size in the outer wall of the wood duck house.

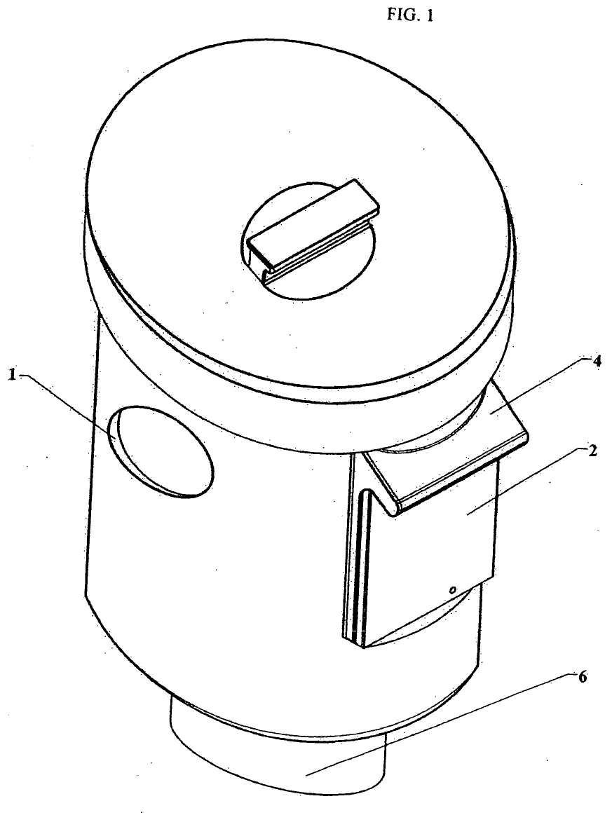

FIG. 2 is a front view of the wood duck house showing the ingress oval hole for the wood duck. The inspection door on the side of the wood duck house fits under the flange. The inspection door is set into the depression on the side of the wood duck house.

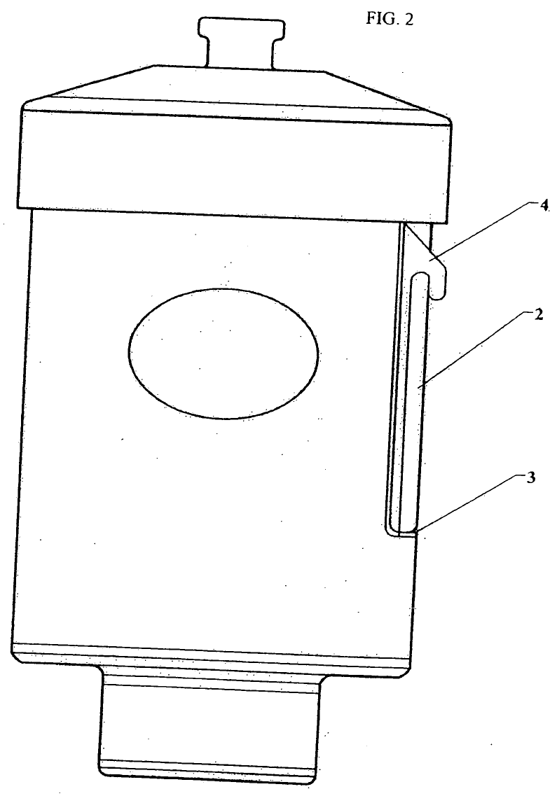

FIG. 3 is a side view of wood duck house showing the inspection door fitting under the flange. This view also shows the wing nut located on the lower end of the inspection door. The wing nut engages the door and the depression in the side of the wood duck house to secure the inspection door for closure.

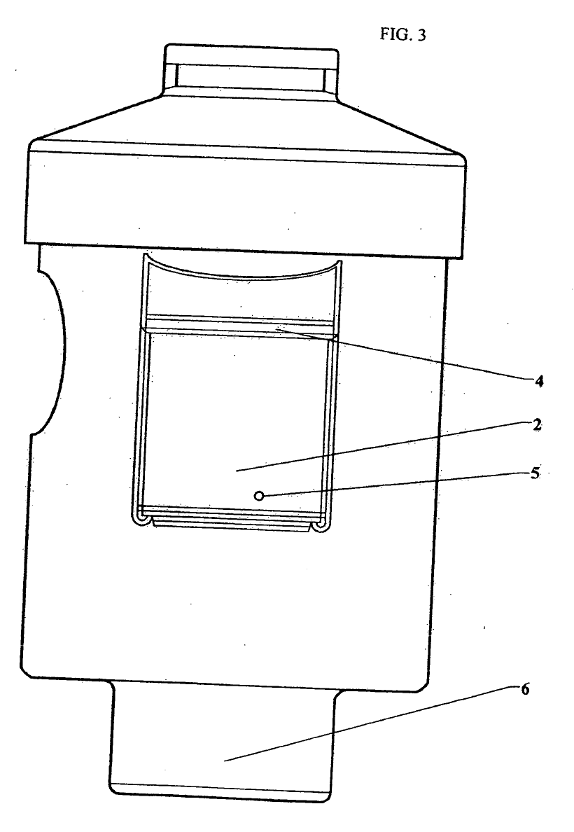

FIG. 4 is a security collar with peg on the inside concave surface of the security collar.

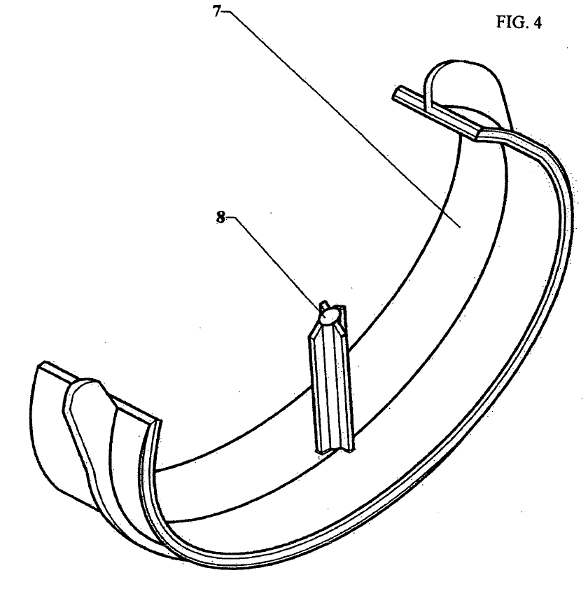

FIG. 5 shows the placement of the peg of the security collar into the neck of the wood duck house which rests upon the top of a PVC pole.

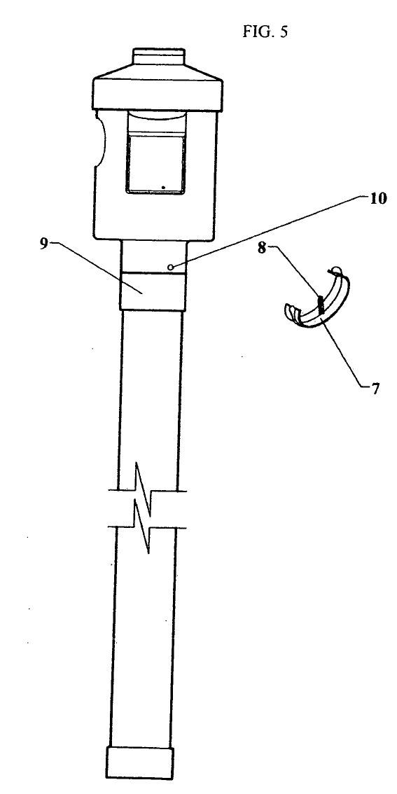

FIG. 6 is the connecting device with the upper end of smaller diameter than the lower end. The upper end of the connecting device also shows an aperture that receives the peg of the security collar.

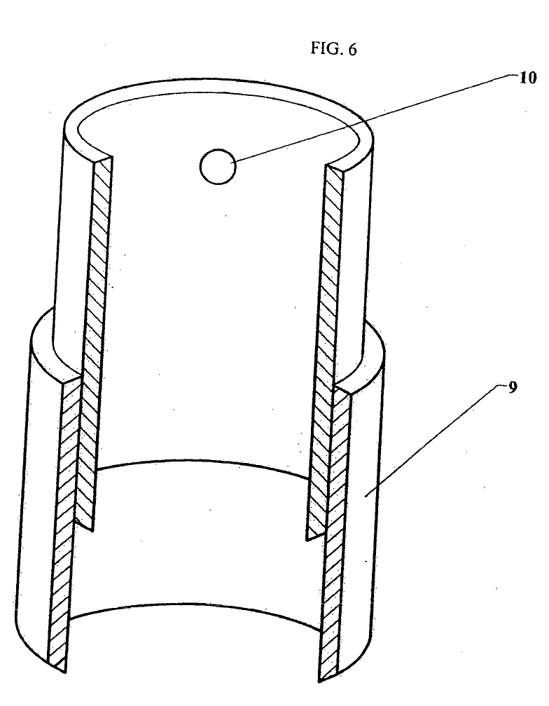

FIG. 7 shows the peg of the security collar engaging the aperture at the upper end of the connecting device. The upper end of the connecting device fits inside the neck of the wood duck house. The lower end fits over and on top of the PVC pole.

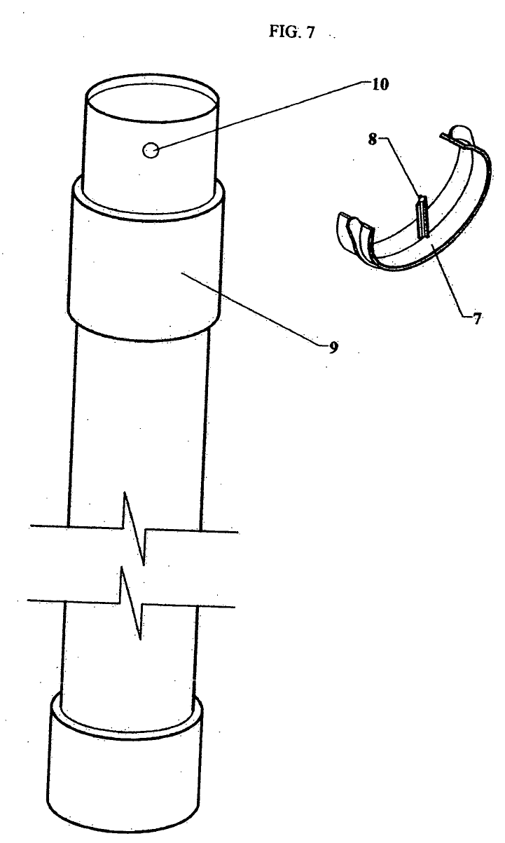

### SUMMARY

A chemical foaming agent used in combination with a plastic material that provides a layer of insulation (1) for a cylindrical plastic wood duck house. The plastic material used to construct the wood duck house in the present invention is infused with a chemical foaming agent that creates spatial openings within the plastic material. The spatial openings create an insulating environment throughout the entire wood duck house.

The inspection door (2) of the present invention fits snugly into a depression (3) of matching size on the side of the cylindrical wood duck house. The inspection door (2) allows for an individual bird enthusiast to inspect the contents of the nest inside the wood duck house. The flange (4) on the side of the wood duck house above the inspection door (2) acts to secure the inspection door (2) in place without additional tools. The inspection door (2) is secured at its lower side with a wing nut (5). The wing nut (5) engages the inspection door (2) to the depression (3) on the side of the wood duck house without requiring additional tools.

The neck (6) at the base of the cylindrical wood duck house rests atop and over a round plastic PVC pole of slightly smaller diameter. The security collar (7) of the present invention snaps snuggly onto the neck (6) of the wood duck house. The peg (8) on the inside concave surface of the security collar (7) fits into an aperture on the neck (6) of the wood duck house and then through a same diameter size aperture on the round plastic PVC pole. The peg (8) on the security collar (7) pierces through the neck (6) of the wood duck house and the PVC pole to stabilize and secure the wood duck house to the PVC pole. The curvature of the security collar (7) matches the curvature of the neck (6) of the wood duck house. This insures a snug fit and ease of securing the wood duck house to the PVC pole without additional tools.

The upper end of a connecting device (9) fits under and inside the neck (6) of the wood duck house. The lower end of the connecting device (9) fits over and to the top of a round plastic PVC pole. The connecting device (9) has an aperture (10) of the same size as the peg (8) on the security collar (7). The connecting device (9) is an adapter coupler to engage the wood duck house above to the round PVC pole below without additional tools. The connecting device (9) eliminates the need for the bird enthusiast to use electric drill tools to drill a hole in the PVC pole. The neck (6) of the wood duck house fits over and on top of the connecting device (9). The connecting device (9) is fitted over and to the top of the PVC pole.

1. An insulated wood duck house made with a chemical foaming agent infused into plastic material to create insulation for a wood duck house. The said chemical foaming agent creates spatial openings in the said plastic material used to manufacture the said wood duck house.

2. An inspection door on the side of the said wood duck house. A flange on the side of the said wood duck house above and extending slightly over the placement for the inspection door serves as a guide to secure the inspection door to the said wood duck house. The inspection door fits inside a depression of the same size on the side of the said wood duck house. The inspection door has a wing nut at its lower end. The wing nut engages the inspection door to an aperture of the same diameter in the depression on the side of the said wood duck house.

3. A C-shaped security collar with a peg centered on its concave surface. The security collar snaps snugly onto the neck of the said wood duck house. The peg of the security collar engages the neck of the said wood duck house then engages the top of a PVC pole to attain height for the said wood duck house.

4. A cylindrical connecting device with an upper end of slightly smaller diameter than its lower end. The upper end of the connecting device fits under and inside the neck of the said wood duck house. The upper end of the connecting device contains an aperture of the same diameter as the said peg on the concave surface of the said security collar. The said peg of the said security collar engages the neck of the said wood duck house and engages the aperture on the upper end of the connecting device. The lower end of the connecting device is fitted over and on top of a PVC pole.
